(19) United States
(12) Patent Application Publication
(10) Pub. No.: US 2006/0224377 A1
(43) Pub. Date: Oct. 5, 2006

(54) ROM emulator

(76) Inventors: Jing Rung Wang, Taipei (TW); Chia-Hsing Yu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/203,190

(22) Filed: Aug. 15, 2005

(30) Foreign Application Priority Data
Apr. 1, 2005 (TW) 094110589

(51) Int. Cl. G06F 9/455

(52) U.S. Cl. 703/24

(57) ABSTRACT

A ROM emulator for testing basic input/output system (BIOS) includes a memory, an emulation controller, and a download interface controller, and can download various versions of BIOS from a computer. When the inventive ROM emulator is connected to a computer motherboard of a computer, it can secure the mastership of the PCI bus of the computer upon the startup of the motherboard so as to test various versions of BIOS.

### FIELD OF THE INVENTION

The present invention is related to a read-only memory (ROM) emulator, and more particularly to a ROM emulator feasible for testing basic input/output system (BIOS), allowing various versions of BIOS to be tested through the installation of a ROM emulator.

### BACKGROUND OF THE INVENTION

With the unceasing uplift of the requirements on the information technology products, the related product supplier is pledged to present a wide variety of new products. In the stage of development, the testing operation to the new product is an important step in the manufacturing process. With the step of product testing, the performance of the product can be substantially appraised. The product test data also can guarantee the ex-factory quality and stability of product, and can be used as an important reference for the design and improvement of the follow-on product. When the computer peripherals are increasingly upgrading and updating, the basic input/output system (BIOS) has to keep consistent with the renovation of computer peripherals so as to tackle the problems in the design of computer motherboard. This can promote the stability of computer system, and thus the computer system can provide technical assistance to newer technology.

Likewise, in the development stage of a new BIOS product, the BIOS product has to undergo numerous testing processes to ensure that the BIOS product can meet the specified function and quality.

In the past BIOS testing process, if the BIOS is slightly modified, the BIOS ROM is needed to be updated with the modified BIOS by flash programming procedure. This would complicate the BIOS testing process and cause inefficient temporal utilization, and further aggravate the cost of design and manufacturing.

### SUMMARY OF THE INVENTION

Therefore, it is a key point of the present invention to devise a novel ROM emulator that can address the drawbacks lasted in the prior art.

The major object of the present invention is to provide a ROM emulator capable of downloading BIOS to the ROM emulator, which is connected to a PCI slot of a motherboard via a PCI connector in order to test the BIOS.

The minor object of the present invention is to provide a ROM emulator having an emulation controller for making translations between the PCI interface standard and a transmission interface standard of a memory and governing the operation of the ROM emulator.

Another object of the present invention is to provide a ROM emulator having a download interface controller and a download interface connector for connecting to a computer and downloading the BIOS codified on the computer to the ROM emulator for testing.

Another yet object of the present invention is to provide a ROM emulator connecting to a computer motherboard and capable of securing the mastership of a PCI bus upon the startup of the motherboard for testing BIOS.

Another yet object of the present invention is to provide a ROM emulator having an internal memory which is implemented by a SRAM or a non-volatile memory to facilitate the modification and storage of BIOS.

Another yet object of the present invention is to provide a ROM emulator having a status information indicator for displaying error messages during the BIOS testing process.

To attain the aforesaid objects, the present invention provides a ROM emulator including a memory for storing a BIOS waiting to be tested, a PCI connector connecting to a motherboard, an emulation controller connected to the memory and the PCI connector for making translations between the PCI interface standard and the transmission interface standard of the memory and governing the operation of the ROM emulator, and a controller connected to the emulation controller and having a download interface connector connected to a computer for downloading the BIOS waiting to be tested.

The foregoing and features and advantages of the present invention will become more apparent through the following descriptions with reference to the accompanying drawings, in which:

### BRIEF DESCRIPTION OF THE DRAWINGS

FIG. 1 is a plan view showing the building blocks of the system configuration according to a preferred embodiment of the present invention.

### DETAILED DESCRIPTION OF THE PREFERRED EMBODIMENT

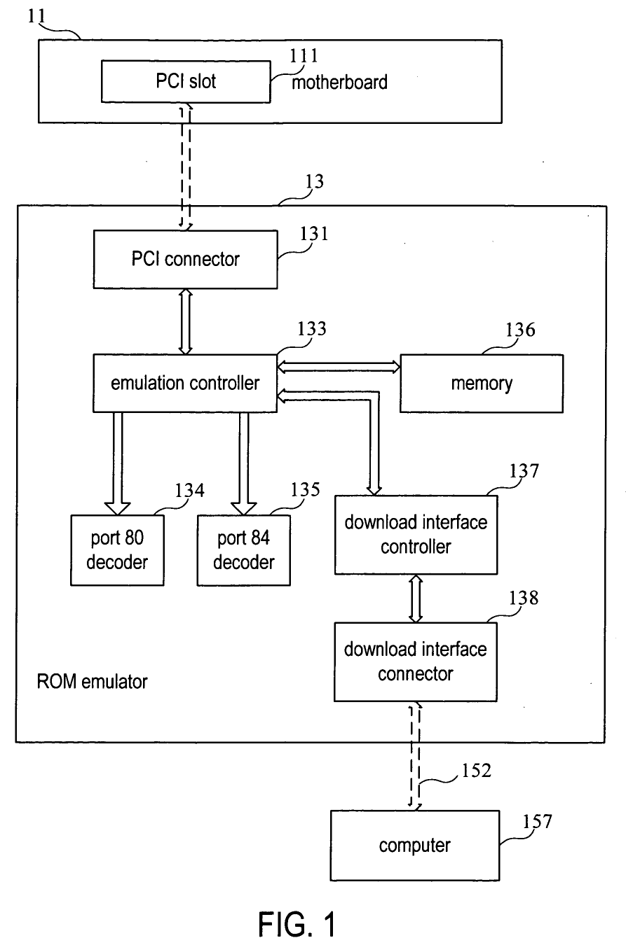

Referring to FIG. 1, a block diagram of the system configuration according to a preferred embodiment of the present invention is illustrated. As shown in FIG. 1, the ROM emulator of the present embodiment includes an emulation controller 133, a PCI connector 131 and a memory 136, wherein the emulation controller 133 is connected to the PCI connector 131 and the memory 136. The memory 136 stores a basic input/output system (BIOS) waiting to be tested.

When the ROM emulator 13 is connected to a PCI slot 111 mounted on a computer motherboard 11, the ROM emulator 13 can secure the mastership of a PCI bus upon the startup of the motherboard. This is done by allowing the emulation controller 133 to perform decoding process and yield acknowledgement in advance of the decoding process initiated by a Southbridge chipset (not shown) to decode the memory read instruction issued by a CPU (not shown). Next, the BIOS stored in the memory 136 can be accessed and tested accordingly.

The ROM emulator 13 further includes a download interface controller 137 and a download interface connector 138, in which the download interface controller 137 is connected to the emulation controller 133 and the download interface connector 138 is connected to a computer 157.

Under the system configuration of the present invention, the BIOS tester can codify or modify the program code of a new version BIOS product on the computer 157. When this is done, the ROM emulator 13 can be connected to the computer 157 via a transmission cable or by connecting the download interface connector 138 to the computer 157, so that the BIOS waiting to be tested and stored in the computer 157 can be downloaded to the ROM emulator 13 via the download interface connector 138 and the download interface controller 137. With the ROM emulator of the present invention, the BIOS tester can accomplish a real-time BIOS test process without performing complicated flash programming procedure which is needed each time the BIOS is renovated.

In the present invention, the memory should be adapted to provide data write and erase function. For example, the memory can be implemented by a static random access memory (SRAM) or a non-volatile memory. The download interface of the download interface controller 137 and the download interface connector 138 can be implemented by a transmission interface with a great transmission speed and expediency, for example, USB interface, IEEE 1394 interface, or a wireless transmission interface, so that the transmission speed and the expediency of the BIOS downloading from the computer 157 to the memory 136 can be enhanced and the overall efficiency of the BIOS testing process can be improved.

In addition, the ROM emulator can optionally provide a status information indicator connected to the emulator controller 133 for displaying the testing status information of the BIOS. In the present embodiment, the status information indicator can be implemented by a decoder 134 using I/O port number 80 for display or a decoder 135 using I/O port number 84 for display. With the installation of the status information indicator, the status information during testing and the problems and errors derived from testing can be displayed on the status information indicator in the form of digits, so that the BIOS tester can keep record of the statistics revealed on the status information indicator and analyze the content of the statistics. This would enable the BIOS tester to have an immediate understanding and confirmation on the status information during testing and the problems derived from testing, and solve the problems incurred instantaneously.

In conclusion, the present invention provides a ROM emulator capable of testing various versions of BIOS. Also, it is known that although the present invention has been described and illustrated in detail, it is to be clearly understood that the same is by the way of illustration and example only and is not to be taken by way of limitation, the spirit and scope of the present invention being limited only by the terms of the appended claims.

What is claimed is:

1. A read-only memory emulator, comprising
a memory for storing a basic input/output system waiting to be tested;
a PCI connector for coupling to a motherboard;
an emulation controller connected to said memory and said PCI connector for translating between said PCI interface standard and a transmission interface standard of said memory and governing said operation of said read-only memory emulator; and
a download interface controller connected to said emulation controller and having a download interface connector for connecting to a computer to download said basic input/output system waiting to be tested.

2. The read-only memory emulator according to claim 1, wherein said read-only memory emulator is configured to secure said mastership of a PCI bus mounted on a motherboard of said computer upon the startup of said motherboard.

3. The read-only memory emulator according to claim 1, wherein said memory is a static random access memory or a non-volatile memory.

4. The read-only memory emulator according to claim 1, wherein said transmission interface standard of said memory is an industrial standard architecture interface standard or a low pin count interface standard.

5. The read-only memory emulator according to claim 1, wherein a download interface of said read-only memory emulator is implemented by a USB interface, an IEEE 1394 interface, or a wireless transmission interface.

6. The read-only memory emulator according to claim 1 further comprising a status information indicator.

7. The read-only memory emulator according to claim 6, wherein said status information indicator is implemented by a decoder using I/O port number 80 for display or a decoder using I/O port number 84 for display.
